(19) United States
(12) Patent Application Publication
(10) Pub. No.: US 2025/0190157 A1
(43) Pub. Date: Jun. 12, 2025

(54) INFORMATION PROCESSING APPARATUS, STORAGE MEDIUM STORING INFORMATION PROCESSING PROGRAM, AND INFORMATION PROCESSING SYSTEM

(71) Applicant: SEIKO EPSON CORPORATION, Tokyo (JP)

(72) Inventor: Kazuki SEKIKAWA, SAPPORO-SHI (JP)

(21) Appl. No.: 18/973,245

(22) Filed: Dec. 9, 2024

(30) Foreign Application Priority Data
Dec. 7, 2023 (JP) 2023-206734

(51) Int. Cl. G06F 3/12; H04N 1/60

(52) U.S. Cl. CPC G06F 3/1255; G06F 3/1205; H04N 1/603

(57) ABSTRACT

An information processing apparatus includes an acquisition section that acquires a colorimetric value of a color sample measured by a colorimeter and a profile to be used for printing performed by a print apparatus, a comparison section for comparing a color gamut of the profile with the colorimetric value, and a controller that displays information indicating that the color sample is printable on a selection screen in association with the print apparatus, when the colorimetric value is within the color gamut of the profile.

The present application is based on, and claims priority from JP Application Serial Number 2023-206734, filed Dec. 7, 2023, the disclosure of which is hereby incorporated by reference herein in its entirety.

### BACKGROUND

### 1. Technical Field

The present disclosure relates to an information processing apparatus, a storage medium storing an information processing program, and an information processing system.

### 2. Related Art

In general, techniques are known to simplify operations associated with colorimetry. For example, JP-A-2022-127868 discloses a technique for determining whether a color measured by a colorimetric section matches a color to be compared in a color group, and when the determination is affirmative, performing colorimetry on a next color in the color group.

In order to reproduce colors shown in color samples, a suitable combination between a profile and a print apparatus is required to be selected. In general, an operation of selecting an appropriate combination is complicated.

### SUMMARY

According to an aspect of the present disclosure, an information processing apparatus includes an acquisition section that acquires a colorimetric value of a color sample measured by a colorimeter and a profile to be used for printing performed by a print apparatus, a comparison section for comparing a color gamut of the profile with the colorimetric value, and a controller that displays information indicating that the color sample is printable on a selection screen in association with the print apparatus, when the colorimetric value is within the color gamut of the profile.

According to another aspect of the present disclosure, a non-transitory computer-readable storage medium storing an information processing program causes a computer to function as an acquisition section that acquires a colorimetric value of a color sample measured by a colorimeter and a profile to be used for printing performed by a print apparatus, a comparison section for comparing a color gamut of the profile with the colorimetric value, and a controller that displays information indicating that the color sample is printable on a selection screen in association with the print apparatus, when the colorimetric value is within the color gamut of the profile.

According to a further aspect of the present disclosure, an information processing system includes an acquisition section that acquires a colorimetric value of a color sample measured by a colorimeter and a profile to be used for printing performed by a print apparatus, a comparison section for comparing a color gamut of the profile with the colorimetric value, and a controller that displays information indicating that the color sample is printable on a selection screen in association with the print apparatus, when the colorimetric value is within the color gamut of the profile.

### BRIEF DESCRIPTION OF THE DRAWINGS

FIG. 1 is a diagram illustrating an entire configuration of a print system.

FIG. 2 is a diagram illustrating a configuration of a colorimeter.

FIG. 3 is a diagram illustrating a configuration of a print apparatus.

FIG. 4 is a diagram illustrating a configuration of an image processing apparatus.

FIG. 5 is a diagram illustrating a configuration of a stock management apparatus.

FIG. 6 is a diagram illustrating a configuration of an information processing apparatus.

FIG. 7 is a flowchart of a print control process.

FIG. 8 is a diagram illustrating whether a colorimetric value is within a color gamut.

FIG. 9 is a diagram illustrating an example of a selection screen.

FIG. 10 is a diagram illustrating an example of the selection screen.

FIG. 11 is a diagram illustrating an example of the selection screen.

FIG. 12 is a diagram illustrating an example of the selection screen.

### DESCRIPTION OF EMBODIMENTS

Hereinafter, embodiments of the present disclosure will be described in the following order.
1 System Configuration
1-1 Configuration of Colorimeter
1-2 Configuration of Print Apparatus
1-3 Configuration of Image Processing Apparatus
1-4 Configuration of Stock Management Apparatus
1-5 Configuration of Information Processing Apparatus
2 Print Control Process
3 Other Embodiments

### 1 System Configuration

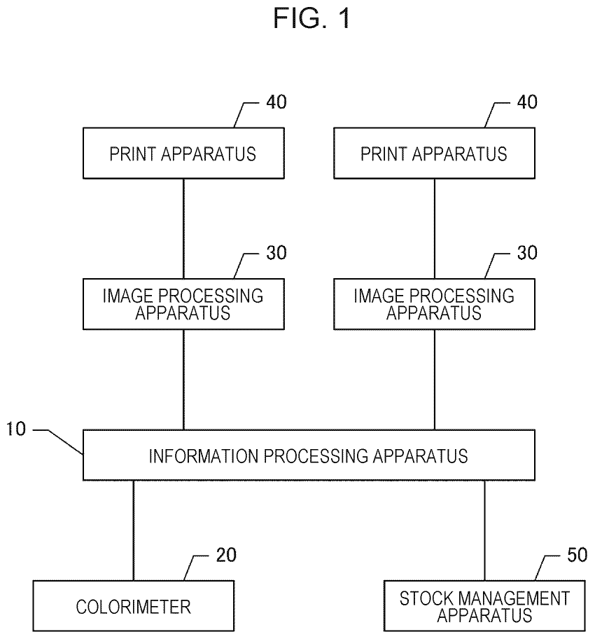

FIG. 1 is a diagram illustrating a configuration of a system capable of selecting an arbitrary print apparatus 40 from among a plurality of print apparatuses 40 to perform printing. The system includes an information processing apparatus 10, a colorimeter 20, image processing apparatuses 30, print apparatuses 40, and a stock management apparatus 50. The information processing apparatus 10 includes a function of indicating whether a color sample measured by the colorimeter 20 is printable by the print apparatuses 40 and a function of causing the print apparatuses 40 to print image data selected by a user. Note that, although two print apparatuses 40 are illustrated in FIG. 1, the number of print apparatuses 40 is arbitrarily set. Furthermore, although an example of one print apparatus 40 being controlled by one image processing apparatus 30 is assumed in this embodiment, a plurality of print apparatuses 40 may be controlled by one image processing apparatus 30, or one print apparatus 40 may be controllable by a plurality of image processing apparatuses 30.

### 1-1 Configuration of Colorimeter

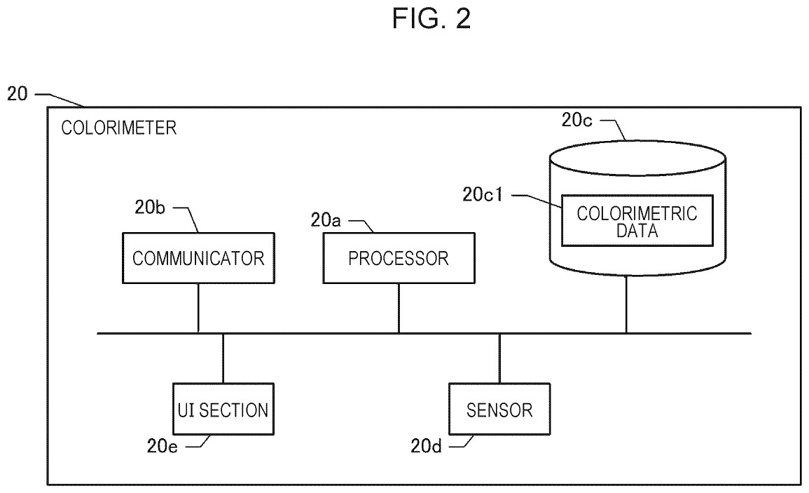

FIG. 2 is a block diagram illustrating a configuration of the colorimeter 20. The colorimeter 20 includes a processor 20a, a communicator 20b, a nonvolatile memory 20c, a sensor 20d, and a UI section 20e. The processor 20a includes a CPU (Central Processing Unit), ROM (Read Only Memory), and RAM (Random Access Memory) which are not illustrated, and may execute a control program recorded in the nonvolatile memory 20c to control the individual sections included in the colorimeter 20.

Note that the processor 20a may be configured by a single chip or a plurality of chips, or configured as an SoC (System-on-Chip) together with various functional blocks. Furthermore, ASIC (Application Specific Integrated Circuits) may be employed instead of the CPU, for example, or the CPU and ASIC may cooperate with each other. When each of the apparatuses in this embodiment includes a processor, the processor may be realized in various modes as well as the processor 20a.

The communicator 20b includes a communication interface for communicating with the information processing apparatus 10 in accordance with various wired or wireless communication protocols. The colorimeter 20 may communicate with the information processing apparatus 10 through the communicator 20b. The sensor 20d is a device that illuminates a colorimetric target with light of a predetermined color temperature so as to detect spectral distribution of the reflected light. Based on a result of reading performed by the sensor 20d, the processor 20a acquires a colorimetric value (e.g., CIELAB value) indicating a color of a colorimetric target by a color in a device independent color space.

In this embodiment, the colorimetric target of the colorimeter 20 is a color sample. Although the color sample may be a color printed on various objects, it is assumed here that a plurality of patches printed on a print medium serve as color samples. When each of the patches is measured by the colorimeter 20, identification information of the patch is associated with a colorimetric value indicating a result of the colorimetry, and is stored in the nonvolatile memory 20c as colorimetric data 20c1.

The UI section 20e is a button or the like disposed in a housing of the colorimeter 20. When operating the UI section 20e, a user may instruct start of colorimetry on the individual patches or the like. The processor 20a receives the instruction issued by the user as output information of the UI section 20e.

### 1-2 Configuration of Print Apparatus

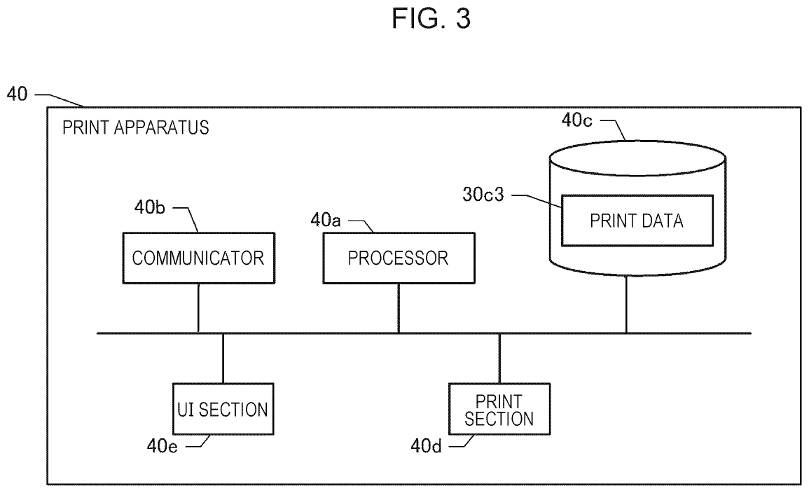

FIG. 3 is a block diagram illustrating a configuration of the print apparatus 40. The print apparatus 40 includes a processor 40a, a communicator 40b, a nonvolatile memory 40c, a print section 40d, and a UI section 40e. The processor 40a includes a CPU, a ROM, and a RAM which are not illustrated, and may execute a control program recorded in the nonvolatile memory 40c so as to control the individual sections of the print apparatus 40.

The communicator 40b includes a communication interface for communicating with the image processing apparatus 30 in accordance with various wired or wireless communication protocols. The print apparatus 40 may communicate with the image processing apparatus 30 through the communicator 40b. Note that the communicator 40b may include an interface for communicating with various removable memories mounted on the print apparatus 40.

The print section 40d includes actuators, various devices, sensors, drive circuits, machine parts, etc., for executing printing on a print medium. The sensors include a sensor that detects various detection targets that may change in the print apparatus 40. Examples of such a sensor include a sensor for detecting an amount of remaining print media and a sensor for detecting an amount of remaining color material for each color to be used for printing. In this embodiment, the print section 40d has a mechanism for recording color materials of predetermined colors (including cyan, magenta, yellow, and black) on a print medium. Furthermore, the print section 40d may perform printing on various sizes of print media. Specifically, the print section 40d includes storages for storing various sizes of print media, and may perform printing while transporting the stored print media.

The UI section 40e includes an input section, such as a button or a touch panel, disposed in the housing of the print apparatus 40, and a display for displaying various information. The user may operate the input section to issue various instructions based on information displayed on the display of the UI section 40e.

The processor 40a of the print apparatus 40 performs printing based on print data 30c3 transmitted from the image processing apparatus 30. That is, when printing is performed, the print data 30c3 is transmitted with a print instruction from the image processing apparatus 30 and stored in the nonvolatile memory 40c. The processor 40a controls the print section 40d and so on based on the print data 30c3 so as to execute printing on print media stored in the print section 40d.

### 1-3 Configuration of Image Processing Apparatus

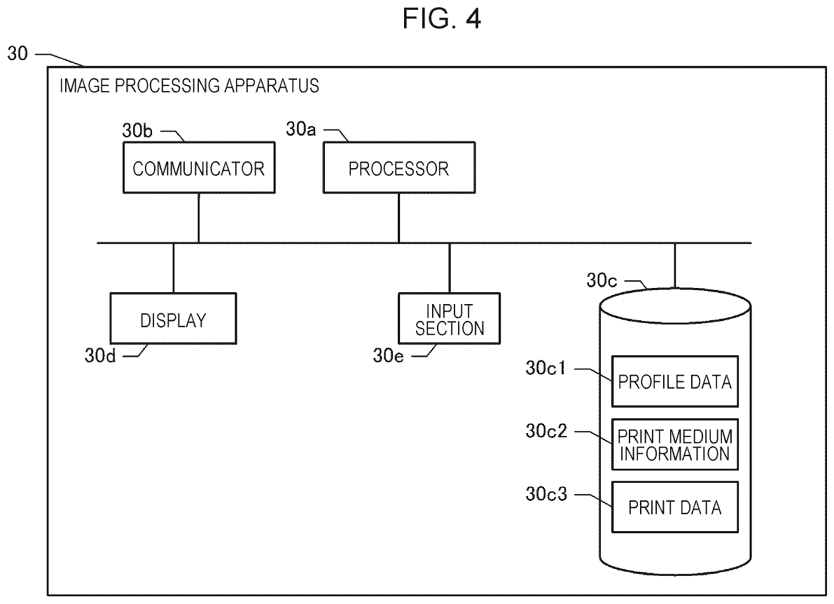

FIG. 4 is a block diagram illustrating a configuration of the image processing apparatus 30. The image processing apparatus 30 includes a processor 30a, a communicator 30b, a nonvolatile memory 30c, a display 30d, and an input section 30e. The processor 30a includes a CPU, a ROM, and a RAM which are not illustrated, and controls the sections included in the image processing apparatus 30 by executing various programs recorded in the nonvolatile memory 30c. Furthermore, the processor 30a may execute various arithmetic processes, such as image processing.

The communicator 30b includes a communication interface for communicating with the information processing apparatus 10 and the print apparatus 40 in accordance with various wired or wireless communication protocols. The image processing apparatus 30 may communicate with the information processing apparatus 10 and the print apparatus 40 through the communicator 30b. Furthermore, the communicator 30b may include an interface for communicating with various removable memories mounted on the image processing apparatus 30.

The display 30d is a display section that displays arbitrary images. The input section 30e is used by the user to perform an input operation, and includes, for example, a keyboard and a mouse. In this embodiment, it is assumed that the image processing apparatus 30 is a terminal of a stationary type, but the image processing apparatus 30 may be a terminal of another mode. For example, the image processing apparatus 30 may be a tablet terminal or a smartphone terminal. In the case of these terminals, the input section 30e may be constituted by a touch panel. In any case, the user may input a user's intention by operating the input section 30e while checking images and text displayed on the display 30d. In this embodiment, the user may operate the input section 30e to specify a type of print media set in the print apparatus 40 connected to the image processing apparatus 30 and a profile to be used for printing performed by the print apparatus 40.

Various types of data may be stored in the nonvolatile memory 30c. In this embodiment, profile data 30c1, print medium information 30c2, and print data 30c3 are stored. The profile data 30c1 is used for color conversion of image data, and is used to associate colors in a device independent color space with colors in a device dependent color space. In this embodiment, the profile data 30c1 includes profile data for color conversion on an input side and profile data for color conversion on an output side.

The profile data for color conversion on the input side is a LUT (Look Up Table) that associates an RGB gradation value as input image data indicating a color in the device dependent color space with a CIELAB value indicating a color in the device independent color space. The profile data that performs color conversion on the output side is a LUT that associates a CIELAB value indicating a color in the device independent color space with a CMYK gradation value as output image data indicating a color in the device dependent color space. Note that the RGB gradation value is a gradation value of each of RGB colors, and the CMYK gradation value is a gradation value of each of colors of the color materials. The number of colors of the color materials is not limited to four, and may match the number of colors of the color materials used in the print apparatus 40. The LUT constituting the individual profiles is data in which the colors in the device dependent color space and the CIELAB values are associated with each other for individual representative colors. In order to perform color conversion on gradation values not specified in the LUT, an interpolation operation process is performed based on the LUT.

Note that, in one print apparatus 40, a plurality of types of profile may be used. For example, profile data for color conversion on the output side is prepared for each type of print media used in the print apparatus 40. Furthermore, the user may prepare and use a desired profile. These plurality of types of profile are included in the profile data 30c1, and the profile data 30c1 includes information indicating a profile that is currently set (specified by the user) as a profile to be used for color conversion. The profile is used for printing on a print media currently set in the print apparatus 40. Note that the profile used for color conversion may be automatically determined. For example, the profile may be automatically determined according to a type of print media.

The print medium information 30c2 indicates a type of print media set in the print apparatus 40 connected to the image processing apparatus 30. The type of print media set in the print apparatus 40 may be identified by various methods. For example, a configuration in which a type of print media set by the user in the print apparatus 40 is specified via the input section 30e or a configuration in which a type of print media set in the print apparatus 40 is specified by information received from the print apparatus 40 via the communicator 30b may be employed.

The print data 30c3 is used to cause the print apparatus 40 to execute printing. In this embodiment, image data 10c2 is transmitted from the information processing apparatus 10 to the image processing apparatus 30, and image processing is performed by the processor 30a to generate the print data 30c3. Specifically, the image data 10c2 includes a printer description language, and the processor 30a performs a rendering process including analysis based on the printer description language and a process of conversion into raster data. In addition, after the rasterization, the processor 30a performs color conversion on the raster data using the profile data 30c1 designated by the user, performs a page layout determination process, a halftone process, etc., on a print medium so as to generate the print data 30c3. When the print data 30c3 is generated, the print data 30c3 is transmitted to the print apparatus 40, and printing is performed.

### 1-4 Configuration of Stock Management Apparatus

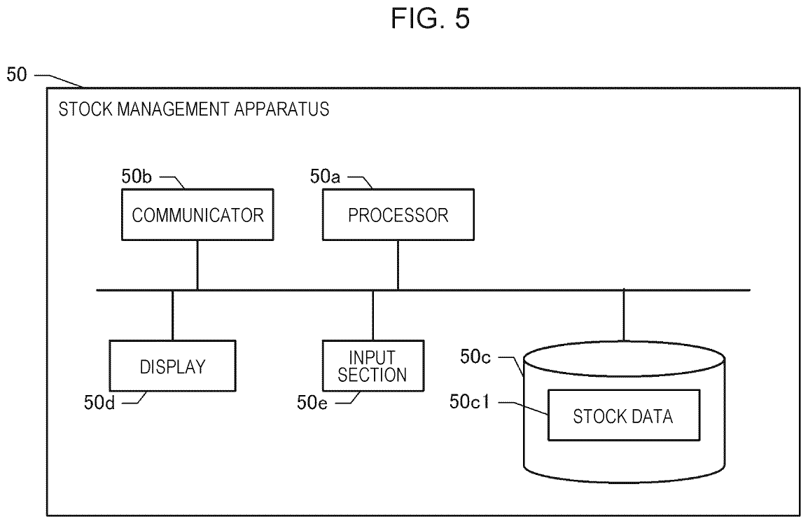

FIG. 5 is a block diagram illustrating a configuration of the stock management apparatus 50. The stock management apparatus 50 includes a processor 50a, a communicator 50b, a nonvolatile memory 50c, a display 50d, and an input section 50e. The processor 50a includes a CPU, a ROM, and a RAM, not illustrated, and controls the sections included in the stock management apparatus 50 by executing various programs recorded in the nonvolatile memory 50c. Furthermore, the processor 50a may execute various processes for managing stock data.

The communicator 50b includes a communication interface for communicating with the information processing apparatus 10 in accordance with various wired or wireless communication protocols. The stock management apparatus 50 may communicate with the information processing apparatus 10 via the communicator 50b. Furthermore, the communicator 50b may include an interface for communicating with various removable memories mounted on the stock management apparatus 50.

The display 50d is a display section that displays arbitrary images. The input section 50e is used by the user to perform an input operation, and includes, for example, a keyboard and a mouse. In this embodiment, it is assumed that the stock management apparatus 50 is a terminal of a stationary type, but the stock management apparatus 50 may be a terminal of another mode. For example, the stock management apparatus 50 may be a tablet terminal or a smartphone terminal. In the case of these terminals, the input section 50e may be constituted by a touch panel. In any case, the user may input a user's intention by operating the input section 50e while checking images and text displayed on the display 50d. In this embodiment, the user may operate the input section 50e to input stock of print media. Note that, in this embodiment, it is assumed that the print apparatus 40 is used in a specific location (e.g., a print station), and a type and an amount of print media stored in the specific location correspond to the stock of print media. The print media are referred to as storage print media. Print media that required to be ordered from a seller of the print media are not the stock.

Various types of data may be stored in the nonvolatile memory 50c. In this embodiment, stock data 50c1 is stored. The stock data 50c1 is information indicating a type and an amount of storage print media. When the storage print media are set in the print apparatus 40, the user inputs a type and an amount of the set print media using the input section 50e. In this case, the processor 50a accepts the type and the amount of the print media and updates the stock data 50c1 by subtracting the type of print media by the amount.

### 1-5 Configuration of Information Processing Apparatus

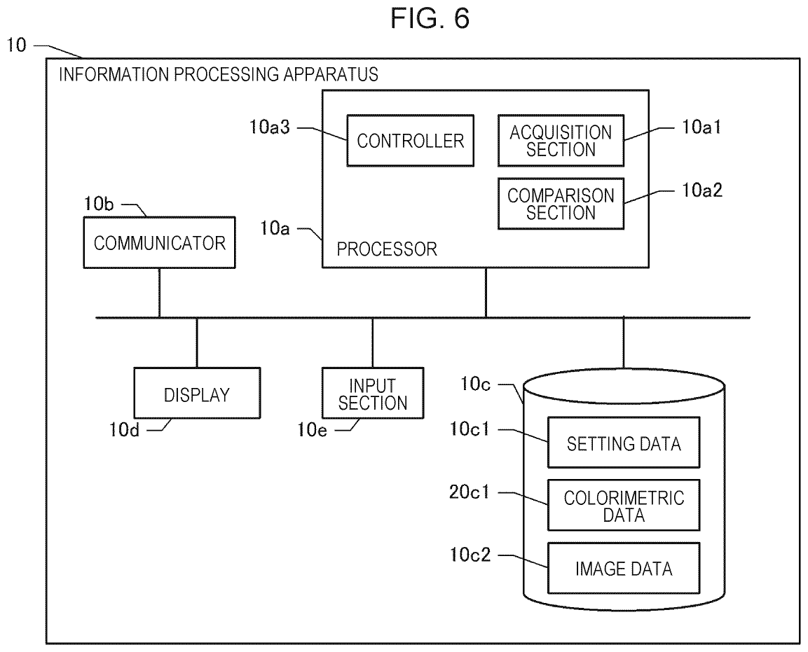

FIG. 6 is a block diagram illustrating a configuration of the information processing apparatus 10. In this embodiment, the information processing apparatus 10 includes a processor 10a, a communicator 10b, a nonvolatile memory 10c, a display 10d, and an input section 10e. The processor 10a includes a CPU, a ROM, and a RAM, not illustrated, and controls the sections included in the information processing apparatus 10, the colorimeter 20, and the like by executing various programs recorded in the nonvolatile memory 10c.

The communicator 10b includes a communication interface for communicating with the colorimeter 20, the image processing apparatus 30, and the stock management apparatus 50 in accordance with various wired or wireless communication protocols. The information processing apparatus 10 may communicate with the colorimeter 20, the image processing apparatus 30, and the stock management apparatus 50 through the communicator 10b. Furthermore, the communicator 10b may also include an interface for communicating with various removable memories mounted on the information processing apparatus 10.

The display 10d is a display device that displays arbitrary images. The input section 10e is used by the user to perform an input operation. The information processing apparatus 10 may be realized in various modes, and may be a stationary computer or a portable computer. In the former case, the display 10d may be separated from a main body of the computer, for example, and the input section 10e may be configured by a keyboard or a mouse separated from the main body of the computer, for example. In the latter case, the display 10d and the input section 10e may be configured as, for example, a touch panel display integrated with the main body of the computer. In any case, the user can input the user's intention by operating the input section 10e while checking images and text displayed on the display 10d. Thereafter, in this embodiment, description will be made assuming that the information processing apparatus 10 is a portable computer. Note that the information processing apparatus 10 may be a tablet terminal, a smartphone terminal, or the like.

The processor 10a may execute an information processing program not illustrated. The information processing program according to this embodiment may display a selection screen for selecting a print apparatus 40 capable of reproducing a color sample measured by the colorimeter 20. The user may select a print apparatus 40 by using the selection screen and cause the print apparatus 40 to execute printing.

Specifically, when the information processing program is executed, the processor 10a functions as an acquisition section 10a1, a comparison section 10a2, and a controller 10a3. The acquisition section 10a1 acquires a colorimetric value of the color sample measured by the colorimeter 20, and a profile used for printing performed by the print apparatus. That is, the acquisition section 10a1 instructs the colorimeter 20 to transmit the colorimetric data 20c1 via the communicator 10b, so that the colorimeter 20 transmits the colorimetric data 20c1. Furthermore, the acquisition section 10al instructs the image processing apparatus 30 to transmit information indicating the profile currently set via the communicator 10b, so that the information indicating the profile currently set in the print apparatus 40 is transmitted.

Moreover, in this embodiment, the acquisition section 10a1 acquires print media set in the print apparatus 40. Specifically, the acquisition section 10a1 instructs the image processing apparatus 30 via the communicator 10b to transmit information indicating a type of print media currently set, so as to cause the image processing apparatus 30 to transmit the print medium information 30c2 indicating a type of print media currently set in the print apparatus 40.

The comparison section 10a2 compares a color gamut of a profile with a colorimetric value. That is, the comparison section 10a2 converts the color using the profile currently set in the print apparatus 40, virtually plots the color gamut obtained when printing on the print media set in the print apparatus 40 within the device independent color space, and determines whether a colorimetric value indicated by the colorimetric data 20c1 is included within the color gamut.

The controller 10a3 is a function for controlling the display 10d so as to display the selection screen for selecting a print apparatus 40 for printing, and cause the selected print apparatus 40 to execute printing. Specifically, in this embodiment, when the colorimetric value is included within the color gamut obtained when printing is performed on a print medium currently set using the profile currently set in the print apparatus 40, the controller 10a3 displays the print apparatus 40 with the profile being set on the selection screen as a print apparatus capable of printing the color sample. According to this display, the user may easily select a suitable combination of a profile and a print apparatus, or a suitable combination of a profile, a type of print media, and a print apparatus.

Furthermore, when the colorimetric value is not included within the color gamut obtained when printing is performed on the print media currently set using the profile currently set in the print apparatus 40, the controller 10a3 displays the print apparatus 40 with the profile being set on the selection screen as the print apparatus 40 which is not capable of printing the color sample. According to this display, the user may easily recognize an unsuitable combination of a profile and a print apparatus, or an unsuitable combination of a profile, a type of print media, and a print apparatus.

Note that information indicating whether a color sample is printable is associated with all of the print apparatuses 40 that may be instructed to start printing by the information processing apparatus 10, and such print apparatuses 40 are displayed in the selection screen in a selectable manner. That is, in the selection screen that displays a plurality of print apparatuses, the print apparatuses 40 that may print the color sample and the print apparatuses 40 that may not print the color sample are displayed in a distinguishable manner. With this configuration, the user may easily and properly select print apparatuses that are available for printing from a plurality of print apparatuses.

In the selection screen, for example, when one print apparatus 40 is selected from a plurality of print apparatuses 40, the processor 10a causes the selected print apparatus 40 to perform printing using the currently set profile on currently set print media. At this time, the user operates the input section 10e to select the image data 10c2 to be printed. When a selection is made by the user, the controller 10a3 transmits the image data 10c2 to be printed to the image processing apparatus 30 connected to the selected print apparatus 40. The image processing apparatus 30 performs processing, such as color conversion, on the image data 10c2 using the currently set profile so as to generate the print data 30c3. Furthermore, the image processing apparatus 30 transmits the print data 30c3 to the print apparatus 40 selected by the user and causes the print apparatus 40 to perform printing. The print apparatus 40 is capable of printing the measured color sample. Accordingly, an image indicated by the image data 10c2 may be printed in a state in which the color of the color sample measured by the user may be reproduced. Note that, although processing relating to the stock management apparatus 50 is omitted in the above description, a print control process including the processing relating to the stock management apparatus 50 is also described in the next print control process.

### 2 Print Control Process

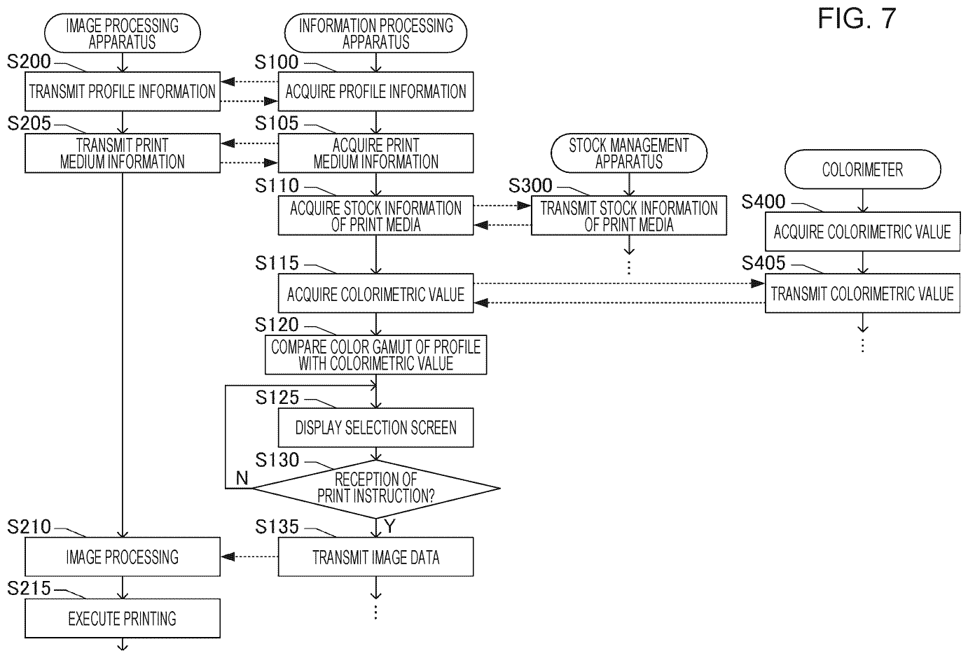

Next, the print control process will be described in detail with reference to a flowchart in FIG. 7. The user prepares the image data 10c2 to be printed and stores the image data 10c2 in the nonvolatile memory 10c before starting the print control process. When printing is started, the user operates the input section 10e of the information processing apparatus 10 to cause the processor 10a to execute the print control program.

When the print control program is started, the processor 10a acquires profile information by the function of the acquisition section 10a1 (step S100). Specifically, the acquisition section 10a1 outputs a transmission instruction of the profile information indicating a profile to the image processing apparatus 30 via the communicator 10b. The processor 30a of the image processing apparatus 30 acquires the profile data 30c1 in response to the transmission instruction, associates identification information of the print apparatus 40 with the profile data 30c1 as profile information, and transmits the profile information to the information processing apparatus 10 (step S200). The processor 10a acquires the transmitted information. As a result, the processor 10a may acquire a profile currently set for each print apparatus 40 from the profile data 30c1. Furthermore, from the profile data 30c1, the processor 10a may acquire a profile, which is not the profile currently set in the print apparatus 40, to be used when print media are changed and printing is performed on the changed print media.

Note that dashed arrows illustrated in FIG. 7 indicate transmission and reception of information (the same applies hereinafter). Furthermore, when a plurality of image processing apparatuses 30 are connected to the information processing apparatus 10 and a print target is selectable from a plurality of print apparatuses 40, the processor 10a communicates with all of the image processing apparatuses 30 and identifies currently set profiles of all the print apparatuses 40.

Subsequently, the processor 10a acquires print medium information by the function of the acquisition section 10a1 (step S105). Specifically, the acquisition section 10a1 issues an instruction for transmitting print medium information indicating a type of print media currently set in the print apparatus 40 to the image processing apparatus 30 via the communicator 10b. The processor 30a of the image processing apparatus 30 refers to the print medium information 30c2 in response to the transmission instruction, and specifies types of print media currently set in the individual print apparatuses 40. Then, the processor 30a associates the types of the currently set print media with the identification information of the print apparatuses 40 as print medium information and transmits the print medium information to the information processing apparatus 10 (step S205). The processor 10a acquires the transmitted information and identifies profiles currently set in the individual print apparatuses 40. In this case also, when the plurality of image processing apparatuses 30 are connected to the information processing apparatus 10 and a print target is selectable from among the plurality of print apparatuses 40, the processor 10a communicates with all the image processing apparatuses 30 and identifies types of currently set print media of all the print apparatuses 40.

Then the processor 10a acquires stock information of the print media by the function of the acquisition section 10a1 (step S110). Specifically, the acquisition section 10a1 outputs an instruction for transmitting stock information of the print media indicating a type and an amount of the storage print media to the stock management apparatus 50 via the communicator 10b. The processor 50a of the stock management apparatus 50 refers to the stock data 50c1 in response to the transmission instruction and specifies types and amounts of the storage print media. Thereafter, the processor 50a transmits the stock information of the print media indicating types and amounts of the storage print media to the information processing apparatus 10 (step S300). The processor 10a acquires the transmitted information and specifies types and amounts of storage print media.

Subsequently, the processor 10a acquires colorimetric values by the function of the acquisition section 10a1 (step S115). However, prior to this, the user performs a colorimetric operation on color samples, for example, before start of execution of the print control program by the information processing apparatus 10. That is, the user operates the colorimeter 20 to measure colors of a plurality of patches indicating color samples. The processor 20a of the colorimeter 20 acquires colorimetric values indicating results of the colorimetry (step S400) and stores the colorimetric data 20c1 indicating the colorimetric values in the nonvolatile memory 20c. Here, for the acquisition of a colorimetric values (step S115), the information processing apparatus 10 may instruct the colorimeter 20 to execute acquisition of colorimetric values indicating colorimetry results (step S400).

With the colorimetric data 20c1 stored, the acquisition section 10a1 outputs an instruction for transmitting the colorimetric values to the colorimeter 20 via the communicator 10b. The processor 20a of the colorimeter 20 acquires the colorimetric data 20c1 in response to the transmission instruction and transmits the colorimetric data 20c1 to the information processing apparatus 10 (step S405). The processor 10a acquires the transmitted information and specifies colorimetric values of the individual color samples.

Next, the processor 10a compares a color gamut of the profile with the colorimetric values by the function of the comparison section 10a2 (step S120). Specifically, the comparison section 10a2 refers to the profiles obtained in step S100, and plots all coordinate values (CIELAB values) in the device independent color space specified in the profile on a virtual CIELAB color space. The comparison section 10a2 also specifies a boundary of the color gamut using the plotted coordinate values. The boundary of the color gamut may be realized, for example, by interpolation operations using coordinate values that exist at an outermost portion.

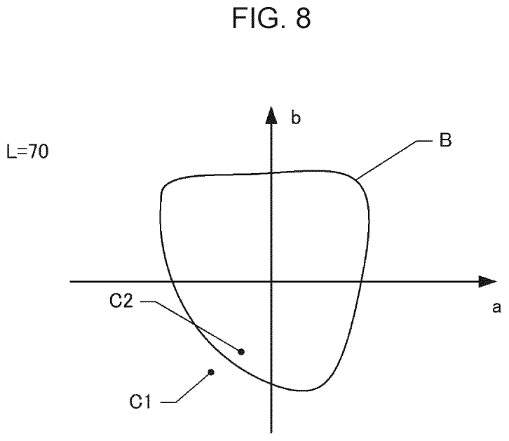

FIG. 8 is a diagram schematically illustrating a boundary B of the color gamut in an ab plane obtained by cutting the CIELAB space in a direction perpendicular to an L-axis at a certain luminosity (L=70). The boundary B of the color gamut forms a closed curve as illustrated in FIG. 8 in the ab plane. The color gamut of the profile is a region inside the boundary B, and any color within the region may be printed by the print apparatus 40, but any color outside the region may not be printed by the print apparatus 40. Accordingly, for example, when the colorimetric value is represented by a coordinate C2, printing is available by the print apparatus 40, but when the colorimetric value is represented by a coordinate C1, printing is available by the print apparatus 40. In other words, a fact that printing is available by the print apparatus 40 indicates a concept in which the colorimetric value is within the color gamut of the profile currently set in the print apparatus 40, and therefore, there is a high probability that print media printed by the print apparatus 40 may reproduce the color sample relatively faithfully. In addition, a fact that printing is not available by the print apparatus 40 indicates a concept in which since the colorimetric value is outside the color gamut of the profile currently set in the print apparatus 40, there is a high probability that the color sample is not relatively faithfully reproduced on the print media printed by the print apparatus 40.

The comparison section 10a2 determines whether all the colorimetric values acquired in step S115 are within the color gamut of the profile. In addition, the comparison section 10a2 determines whether the colorimetric values of all the profiles acquired in step S100 are within threshold values of the profiles.

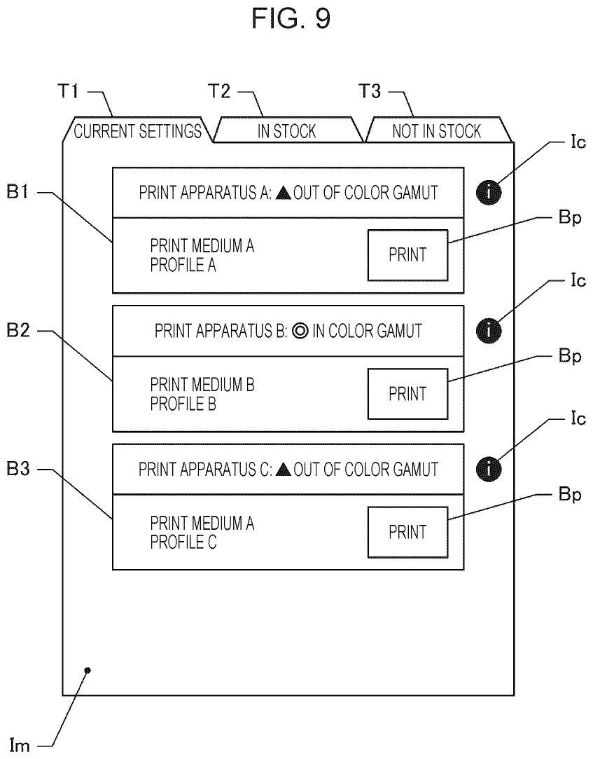

Subsequently, the processor 10a displays the selection screen by the function of the controller 10a3 (step S125). That is, the controller 10a3 controls the display 10d so as to display the selection screen for selecting the print apparatus 40 for printing. FIGS. 9 to 12 are diagrams illustrating display examples of the selection screen. In these screens, information about selectable print apparatuses 40 is displayed for individual print apparatuses 40 in a main screen Im.

Furthermore, the main screen Im displays print apparatuses 40 conforming to a predetermined condition, and the condition may be switched by tabs T1 to T3. The tab T1 is used to display options of the print apparatuses 40 when printing is performed with current settings. Although the tab T2 is used to display options of the print apparatuses 40 when the printing is performed using the storage print media without the current settings. The tab T3 is used to display options of the print apparatuses 40 when the printing is performed using print media that are not reserved for stock without the current settings.

When the tab T1 is selected, the controller 10a3 extracts the currently set profiles from the profile data 30c1 acquired in step S100, and specifies a profile to be used for printing with the print media acquired in step S105. Then the controller 10a3 acquires a result of comparison between a color gamut and a colorimetric value obtained in step S120 for the specified profile. Thereafter, the controller 10a3 controls the display 10d so as to display a type of the print media, a name of the profile, information on whether a color of a color sample is within a color gamut, and a button for instructing execution of printing which are associated with a name of the print apparatus. Such display is performed for each print apparatus 40.

In the example of FIG. 9, the tab T1 is selected. In this example, boxes B1 to B3 indicating options of three print apparatuses 40 are displayed. In each of the boxes B1 to B3, a name of a print apparatus, a type of print media, and a name of profile are displayed. For example, the name of the print apparatus shown in the box B1 is “print apparatus A”, the type of print media is “print medium A”, and the name of the profile is “profile A”.

Beside the name of the print apparatus, an icon and a character string indicating whether a color of a color sample falls within a color gamut of the profile currently set for the print apparatus. In this embodiment, a black triangle indicates out-of-color-gamut, and a double circle indicates in-color-gamut. The former icon is information indicating that the color sample is not printable, and the latter icon is information indicating that the color sample is printable. For example, when printing is performed on the print media A with the profile A currently set in the print apparatus A as illustrated in FIG. 9, at least one color of the color samples is out of the color gamut. On the other hand, when printing is performed on print media B with a profile B currently set in a print apparatus B as illustrated in FIG. 9, all the colors of the color samples are within the color gamut.

Print buttons Bp are displayed beside the types of print media and the names of the profiles. When the user operates the input section 10e to issue an instruction by one of the print buttons Bp, it is regarded that execution of printing by the print apparatus 40 corresponding to the print button Bp has been instructed. According to the above selection screen, the user may easily select a print apparatus capable of reproducing a color of a color sample measured by the user so that the print apparatus performs printing using the image data 10c2.

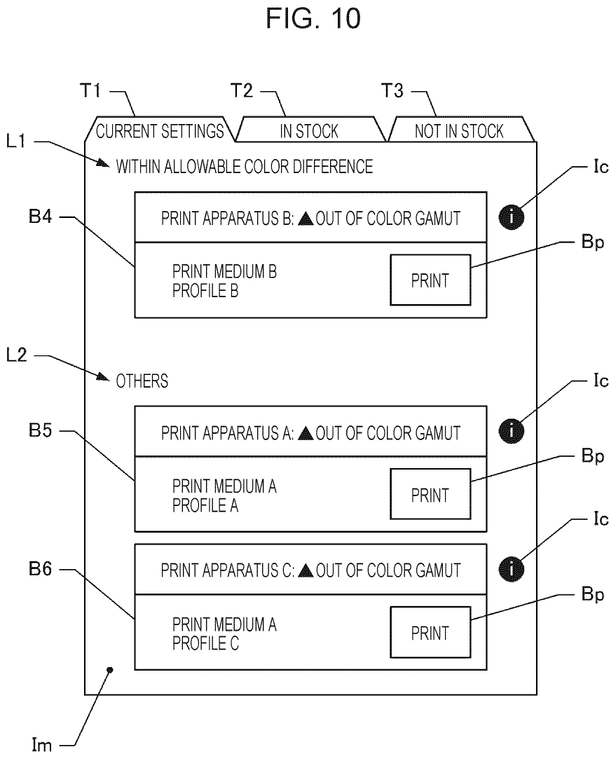

Although FIG. 9 is the diagram illustrating the example in which the profile in which the color of the color sample is within the color gamut in the current settings exists, when there is no profile in which the color of the color sample is within the color gamut in the current settings, boxes of print apparatuses 40 simply indicated as out of color gamut may be listed, and other information may be added. FIG. 10 is a diagram illustrating an example in which information for making a better selection is added when there is no profile in which a colorimetric value indicating a color of a color sample is within a color gamut in the current settings. Specifically, in FIG. 10, a print apparatus using a profile in which a color difference from a colorimetric value is within an allowable color difference is displayed on the selection screen.

Specifically, print apparatuses 40 capable of performing printing with the current settings in FIG. 10 are print apparatuses B, A, and C, but in the example illustrated in FIG. 10, any of the print apparatuses B, A, and C is not capable of printing a color of a color sample. However, even in this case, when a print apparatus in which a largest value of a color difference between the colorimetric value indicating the color of the color sample and the color gamut is small is used, a reproduction degree of the color is higher than that of a print apparatus having a large largest value.

Therefore, the controller 10a3 acquires color differences between color gamuts of profiles currently set in the individual print apparatuses and colorimetric values out of the color gamuts so as to acquire a largest value of the color differences. Note that a color difference between a colorimetric value and a color gamut is indicated by a length of a vertical line extending from the colorimetric value to a color gamut boundary in a CIELAB space. Furthermore, the print apparatus 40 in which the largest value is equal to or less than a predetermined allowable color difference is regarded as a print apparatus capable of performing printing within the allowable color difference.

Then, the controller 10a3 controls the display 10d so as to associate a character string L1 indicating the allowable color difference with the print apparatus 40 capable of performing printing within the allowable color difference, and associate a character string L2 indicating the other print apparatuses with print apparatuses 40 not capable of performing printing within the allowable color difference. According to the above selection screen, the user may easily select a print apparatus capable of printing a color as close as possible to a color of a color sample measured by the user so that the print apparatus performs printing using the image data 10c2. Note that a determination as to whether a color difference from a colorimetric value is within the allowable color difference is made by various methods. For example, when one or more colorimetric values out of the color gamut exist, it may be determined whether a color difference from the colorimetric value is within the allowable color difference based on whether a value integrating the color difference between each colorimetric value and the boundary of the threshold value is below the threshold value.

When the tab T2 is selected, the controller 10a3 extracts the profile to be used for printing on the storage print medium from the profile data 30c1 acquired in step S100 although the profile is not currently set, and specifies the profile to be used for printing on the storage print medium acquired in step S110. Furthermore, the controller 10a3 acquires a result of comparison between a color gamut and a colorimetric value obtained in step S120 for the specified profile. Then, the controller 10a3 controls the display 10d so as to display a type of storage print media, a name of the profile, information on whether a color of a color sample is within a color gamut, and a button for instructing execution of printing which are associated with a name of the print apparatus. Such display is performed for each print apparatus 40.

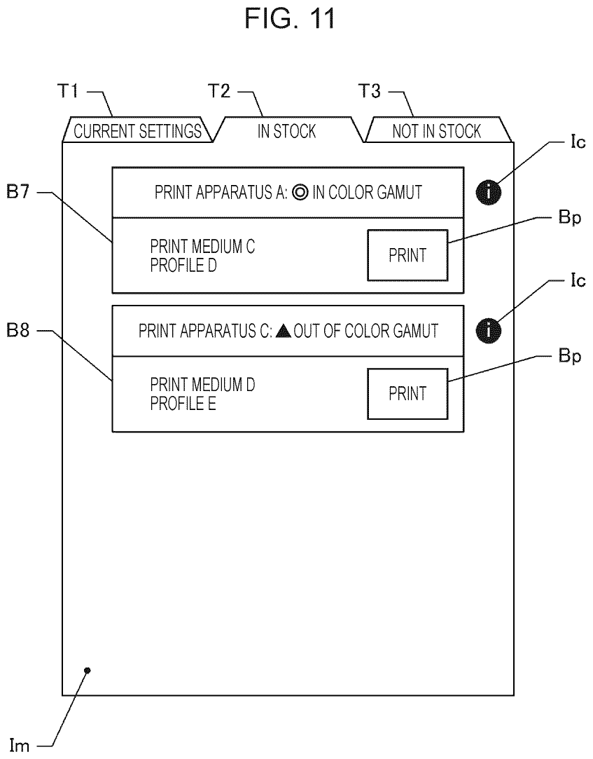

In the example of FIG. 11, the tab T2 is selected. In this example, boxes B7 and B8 indicating options of two print apparatuses 40 are displayed. The information displayed in each of the boxes B7 and B8 is similar to the example illustrated in FIG. 9. The print apparatus A in the box B7 can print a color of a color sample when printing is performed on a print medium C using a profile D. Note that the print medium C is a medium that is not set in the print apparatus A but is stored as a storage print medium.

In FIG. 11 also, when the colorimetric value is within the color gamut in printing on the storage print medium using the profile, an icon of a double circle, which is information indicating that a color sample may be printed using the storage print medium, is displayed on the selection screen in association with the print apparatus. Therefore, the user may easily select a print apparatus that can reproduce a color of a color sample measured by the user by using the storage print medium.

When the tab T3 is selected, the controller 10a3 extracts, from the profile data 30c1 acquired in step S100, a profile to be used for printing on a print medium which is not currently set or which is not the storage print medium, and specifies a profile to be used for printing on the print medium, which is not currently set or which is not the storage print medium, obtained in step S110. Furthermore, the controller 10a3 acquires a result of comparison between a color gamut and a colorimetric value obtained in step S120 for the specified profile. Then, the controller 10a3 controls the display 10d so as to display a type of print media which is not stocked, a name of the profile, information on whether a color of a color sample is within a color gamut, and a button for instructing execution of printing which are associated with a name of the print apparatus. Such display is performed for each print apparatus 40.

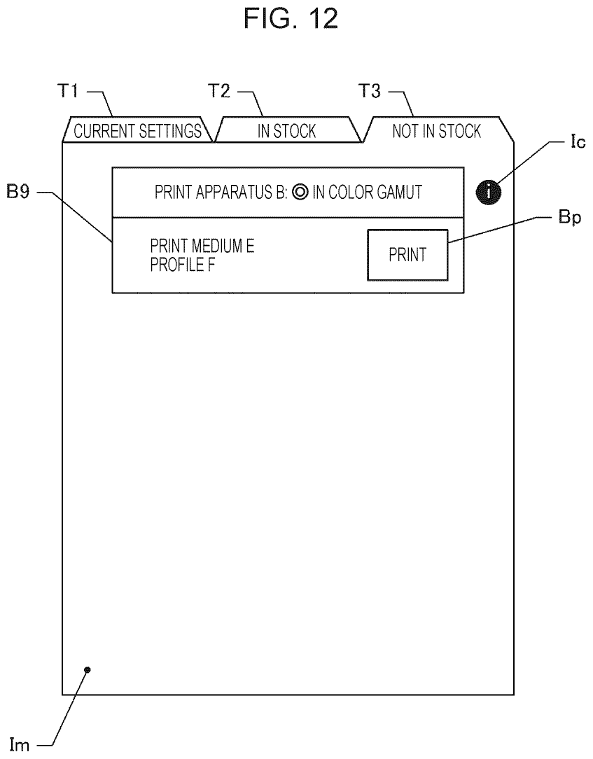

In the example of FIG. 12, the tab T3 is selected. In this example, a box B9 indicating an option of one print apparatus 40 is displayed. The information displayed in the box B9 is similar to the example illustrated in FIG. 9. The print apparatus B in the box B9 can print a color of a color sample when printing is performed on a print medium E using a profile F.

In FIG. 12 also, when printing is performed by ordering a print medium that is not in stock and setting the print medium on the print apparatus, a double circle icon, which is information indicating that a color sample may be printed, is displayed on the selection screen in association with the print apparatus. Therefore, the user may easily select a print apparatus that may reproduce a color of a color sample measured by the user by ordering a print medium which is not stocked and setting the print medium on the print apparatus. Note that, in the tab T3, an order button may be displayed instead of the display of the print buttons Bp. The order button is used for transition to a screen for ordering the print media E from a seller, for example, via an Internet line, in order to order the print media E that are not in stock. Since the order button is disposed on the tab T3, a period of time required for the user to obtain and print appropriate print media may be reduced.

Furthermore, in this embodiment, additional information may be displayed in a pop-up window. Icons Ic attached to right sides of the boxes illustrated in FIGS. 9 to 12 are used to issue an instruction for a pop-up display of the additional information when the additional information is attached to the corresponding print apparatuses. For example, the pop-up display is performed when the user issues an instruction by operating the input section 10e, such as tapping on the icon IC.

Various types of content may be displayed in the pop-up display. For example, when a colorimetric value is out of a color gamut of a profile, a configuration for performing display for prompting a change of current print settings in a print apparatus may be employed. Specifically, in the example of FIG. 9, when an instruction is issued by the icon Ic displayed on the right side of the box B1 for selecting the print apparatus A, the controller 10a3 may control the display 10d and employ a configuration for performing a pop-up display for prompting a change of the print media or the profile of the print apparatus A or the like.

It is preferable that a combination that realizes in-color-gamut when the change is performed is guided in the pop-up display. That is, the controller 10a3 refers to the comparison result obtained in step S120 and determines whether a combination, available for the print apparatus A, which is different from a combination between a profile currently set and print media currently set and which corresponds a colorimetric value within the color gamut exists. When a combination in which the colorimetric value falls within the color gamut exists, the controller 10a3 specifies the profile and the print media to be displayed on a pop-up display screen. According to this configuration, the user may easily recognize a combination capable of printing a color of a color sample by changing a setting even when the color of the color sample may not be printed with the current settings.

In the state in which the above-described selection screen is displayed, the controller 10a3 determines whether a print instruction issued by the user has been received (step S130). That is, the controller 10a3 determines whether an instruction has been issued by one of the print buttons Bp. Since the print buttons Bp are displayed so as to correspond to the print apparatuses 40, in this embodiment, each of the print apparatuses 40 is selectable when a colorimetric value is within a color gamut of a profile, and in addition, when the colorimetric value is out of the color gamut of the profile. However, when the colorimetric value is out of the color gamut of the profile, the print apparatus may be displayed as non-selectable.

When it is not determined in step S130 that the print instruction issued by the user has been received, the controller 10a3 repeatedly performs the process after step S125. When the print instruction issued by the user has been received in step S130, the controller 10a3 transmits the image data 10c2 to the image processing apparatus 30 that controls the indicated print apparatus 40 (step S135). That is, the controller 10a3 specifies the print apparatus 40 associated with the print button Bp instructed by the user as a print target, and specifies the profile associated with the print button Bp. Then the controller 10a3 transmits the image data 10c2 together with information instructing color conversion using the profile and the print instruction to the image processing apparatus 30 connected to the print apparatus 40 which is the print target. The image processing apparatus 30 receives such information, performs image processing based on the indicated profile, and generates the print data 30c3 (step S210). Then, the image processing apparatus 30 transmits the print data 30c3 to the print apparatus 40 which is the print target, and causes the print apparatus 40 to perform printing (step S215). According to the above configuration, the user may easily select the print apparatus 40 capable of printing a color of a color sample and cause the print apparatus 40 to perform printing.

### 3 Other Embodiments

The foregoing embodiment is merely an example for embodying the present disclosure and various other embodiments may be employed. For example, the information processing apparatus 10 and the other apparatuses (at least one of the colorimeter 20, the image processing apparatus 30, the print apparatus 40, and the stock management apparatus 50) may be mounted as one unit. Moreover, connection modes between the apparatuses are not limited to the configuration illustrated in FIG. 1, and communication between arbitrary apparatuses may be performed through an arbitrary network. Furthermore, at least some of the functions of the individual apparatuses may be distributed among a plurality of apparatuses, and for example, at least some of the functions of the information processing apparatus 10 may be realized by a cloud server. In addition, at least some of the functions of the information processing apparatus 10 may be realized by the other apparatuses and configured as an information processing system.

The acquisition section at least acquires a colorimetric value of a color sample measured by the colorimeter, and a profile used for printing performed by the print apparatus. That is, the acquisition section acquires information for identifying display content to be displayed on the selection screen. The colorimeter at least measures a colorimetric value as a device independent color of an arbitrary color. The device independent color space may be various color spaces and is not limited to the CIELAB color space described above. For example, the device independent color space may be an XYZ color space, a CIELUV color space, an SRGB color space, etc.

The color sample at least indicates a color to be reproduced by the user using the print apparatus, and the number of colors is not limited. In addition, the color sample may be a color of a color sample provided by various manufacturers or a color of a color sample provided by the user. The color sample may be provided for colorimetry, such as a color chart, a color of an article, or a color on a label attached to a sample, for example.

The profile at least includes data, such as a LUT and functions, that is referenced during color conversion. The profile is used for printing by the print apparatus and may be set by the user or set by default for use in the print apparatus. In addition, the profile may be changed depending on print conditions in the print apparatus, such as print media and a type of color material to be used.

The comparison section at least compares a color gamut of a profile with a colorimetric value. That is, the comparison section at least identifies the positional relationship between the color gamut of the profile and the colorimetric value. The color gamut indicates a range of colors that can be printed in printing by the print apparatus and may be specified based on the profile.

When a colorimetric value is within a color gamut of a profile, the controller at least displays a print apparatus as a print apparatus capable of printing a color sample on the selection screen. In other words, when the controller can control display content of the selection screen and is in a state in which a color sample may be reproduced by the print apparatus, the controller at least displays the print apparatus in a selectable manner. The selection screen may be a screen on which a print apparatus is selectable, and may be in various modes. For example, as in the embodiment described above, not only a configuration for selecting a print apparatus which performs printing, but also a configuration for selecting a print apparatus to which a setting of the current profile is applied may be employed.

Furthermore, the system, the program, and the method described above may be realized as a solo device or realized using components included in a plurality of devices, and various modes are included in the present disclosure. Furthermore, various modifications may be appropriately made, such as a configuration in which a portion is realized by software or a portion is realized by hardware. Furthermore, the present disclosure includes a recording medium for a program controlling the apparatuses and the system. The recording medium for a program may be a magnetic recording medium, a semiconductor memory, or any recording medium that may be developed in the future.

What is claimed is:

1. An information processing apparatus, comprising:
an acquisition section that acquires a colorimetric value of a color sample measured by a colorimeter and a profile to be used for printing performed by a print apparatus;
a comparison section for comparing a color gamut of the profile with the colorimetric value; and
a controller that displays information indicating that the color sample is printable on a selection screen in association with the print apparatus, when the colorimetric value is within the color gamut of the profile.

2. The information processing apparatus according to claim 1, wherein
the controller displays the print apparatus capable of printing the color sample and the print apparatus not capable of printing the color sample in a distinguishable manner on the selection screen for displaying the plurality of print apparatuses.

3. The information processing apparatus according to claim 1, wherein
the controller displays information indicating that the color sample is not printable on the selection screen in association with the print apparatus when the colorimetric value is out of the color gamut of the profile.

4. The information processing apparatus according to claim 1, wherein
the acquisition section acquires a plurality of the profiles, and
the controller displays, on the selection screen, the print apparatus using the profile in which a color difference from the colorimetric value is within an allowable color difference, when the profile in which the colorimetric value is within the color gamut does not exist.

5. The information processing apparatus according to claim 1, wherein
when the colorimetric value is out of the color gamut of the profile, the controller performs display for prompting a change in a current print setting of the print apparatus on the selection screen.

6. The information processing apparatus according to claim 1, wherein
the controller selectably displays the print apparatus when the colorimetric value is within the color gamut of the profile, and instructs the print apparatus to perform printing when a selection of the print apparatus is received.

7. The information processing apparatus according to claim 1, wherein
the acquisition section acquires a print medium set in the print apparatus,
the comparison section compares the color gamut and the colorimetric value when printing is performed on the print medium using the profile, and
the controller displays information indicating that the color sample is printable on the selection screen in association with the print apparatus when the colorimetric value is within the color gamut obtained when printing is performed on the print medium using the profile.

8. The information processing apparatus according to claim 1, wherein
the acquisition section acquires a storage print medium that is not set in the print apparatus and is stored as a stock,
the comparison section compares the color gamut and the colorimetric value obtained when printing is performed on the storage print medium using the profile, and
the controller displays information indicating that the color sample is printable on the storage print medium on the selection screen in association with the print apparatus when the colorimetric value is within the color gamut obtained when printing is performed on the storage print medium using the profile.

9. A non-transitory computer-readable storage medium storing an information processing program that causes a computer to function as:
an acquisition section that acquires a colorimetric value of a color sample measured by a colorimeter and a profile to be used for printing performed by a print apparatus;
a comparison section for comparing a color gamut of the profile with the colorimetric value; and
a controller that displays information indicating that the color sample is printable on a selection screen in association with the print apparatus, when the colorimetric value is within the color gamut of the profile.

10. An information processing system, comprising:
an acquisition section that acquires a colorimetric value of a color sample measured by a colorimeter and a profile to be used for printing performed by a print apparatus;
a comparison section for comparing a color gamut of the profile with the colorimetric value; and
a controller that displays information indicating that the color sample is printable on a selection screen in association with the print apparatus, when the colorimetric value is within the color gamut of the profile.
